(19) United States
(12) Patent Application Publication
(10) Pub. No.: US 2018/0314995 A1
(43) Pub. Date: Nov. 1, 2018

(54) DIRECTED UNMANNED AIRCRAFT FOR ENHANCED POWER OUTAGE RECOVERY

(71) Applicant: INTERNATIONAL BUSINESS MACHINES CORPORATION, Armonk, NY (US)

(72) Inventors: JEFFREY S. KATZ, WEST HARTFORD, CT (US); AMITH SINGHEE, BENGALURU (IN)

(21) Appl. No.: 15/801,334

(22) Filed: Nov. 2, 2017

Related U.S. Application Data
(63) Continuation of application No. 15/582,872, filed on May 1, 2017.

(51) Int. Cl. G06Q 10/06; G06Q 50/06; G06N 5/02

(52) U.S. Cl. CPC G06Q 10/0631; G06Q 50/06; G06N 5/022

(57) ABSTRACT

Methods, systems and computer program products for enhancing power outage recovery using a drone are provided. Aspects include identifying a predicted damage area based on one or more forecast models of a weather event and staging a drone in the predicted damage area prior to the weather event. Aspects also include dispatching the drone to survey one or more portions of the predicted damage area after the weather event and assessing damage to infrastructure equipment in the one or more portions of the predicted damage area. Aspects further include dispatching a repair crew based on the assessed damage.

### DOMESTIC PRIORITY

This application is a continuation of U.S. patent application Ser. No. 15/582,872, filed May 1, 2017, the disclosure of which is incorporated by reference herein in its entirety.

### BACKGROUND

The present invention relates generally to systems, methods and computer program products for enhancing electric power outage recovery using unmanned aerial vehicles and, more specifically, to systems, methods and computer program products for using unmanned aerial vehicles, also referred to herein as drones, to identify the type of damage that needs to be repaired prior to dispatching a repair crew.

Weather events can impact physical infrastructure in a number of ways. Power generation and distribution systems, water supply lines, gas pipelines, and telecommunication networks are exemplary systems that may be impacted and require recovery and repair. Providers of services and utilities monitor weather forecasts to identify regions in which infrastructure may be impacted. By predicting areas where recovery and repair efforts may increase due to weather induced damage, the providers are able to move equipment and personnel, as needed, to minimize the impact of weather-related infrastructure damage.

Recently, computerized models have been developed that are used to predict damage to infrastructure equipment caused by weather events. In one example, such models can determine where power outages might occur and recommend a preplacement of repair crews. Currently, after a weather event repair crews are dispatched to various locations near their preplacement locations to survey the damage to the infrastructure equipment, these locations are often based on service outages reported by customers or indicated by smart devices within the infrastructure equipment (typically smart meters). The time spent by repair crews surveying damaged equipment reduces the amount of time that the repair crews can spend actually repairing the damaged equipment, and delays the actual repair efforts.

Therefore, heretofore unaddressed needs still exist in the art to address the aforementioned deficiencies and inadequacies.

### SUMMARY

Embodiments include methods, systems, and computer program products for enhancing power outage recovery using a drone are provided. Aspects include identifying a predicted damage area based on one or more forecast models of a weather event and staging a drone in the predicted damage area prior to the weather event. Aspects also include dispatching the drone to survey one or more portions of the predicted damage area after the weather event and assessing damage to infrastructure equipment in the one or more portions of the predicted damage area. Aspects further include dispatching a repair crew based on the assessed damage.

Additional features are realized through the techniques of the present invention. Other embodiments and aspects of the invention are described in detail herein and are considered a part of the claimed invention. For a better understanding of the invention with the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features of embodiments of the invention are apparent from the following detailed description taken in conjunction with the accompanying drawings in which:

FIG. 1 depicts a block diagram of an unmanned aerial vehicle in accordance with an embodiment;

FIG. 2 depicts a block diagram of a controller for an unmanned aerial vehicle in accordance with an embodiment;

FIG. 3 depicts a plan view of a system for enhancing power outage recovery using unmanned aerial vehicles in accordance with an embodiment;

FIG. 4 depicts a flow diagram of a method for enhancing power outage recovery using unmanned aerial vehicles in accordance with an embodiment;

FIG. 5 depicts a cloud computing environment according to an embodiment of the present invention; and

FIG. 6 depicts abstraction model layers according to an embodiment of the present invention.

### DETAILED DESCRIPTION

Embodiments include systems, methods and computer program products for enhancing power outage recovery using unmanned aerial vehicles. In exemplary embodiments, unmanned aerial vehicles, referred to herein as drones, are pre-positioned in predicted damage areas prior to the occurrence of a weather event. The predicted damage areas can be identified based on a variety of known techniques, including those described in U.S. Pat. No. 9,536,214 entitled Weather-driven multi-category infrastructure impact forecasting, the contents of which are incorporated by reference. In exemplary embodiments, the drones include cameras that are used to capture images that are analyzed to assess damage to infrastructure equipment caused by the weather event. In exemplary embodiments, the one or more portions of the predicted damage areas 210 that are surveyed by the drone 206 can be identified based on data received from smart devices, such as smart meters, disposed within the infrastructure, from calls reporting damage or service outages, or from various other sources. The captured images are analyzed to determine a type and location of damage caused by the weather event and this information is used to dispatch repair crews.

In exemplary embodiments, the use of drones to survey the predicted damage areas after weather events enable faster identification and repair of damage to infrastructure equipment caused by the weather event. Pre-positioning the drones in the predicted damage areas prior to the occurrence of a weather event reduces the flying time for drones to reach the predicted damage area, preserving flight time (fuel or charge) for the actual survey, and not the trip from the service center to the predicted damage area.

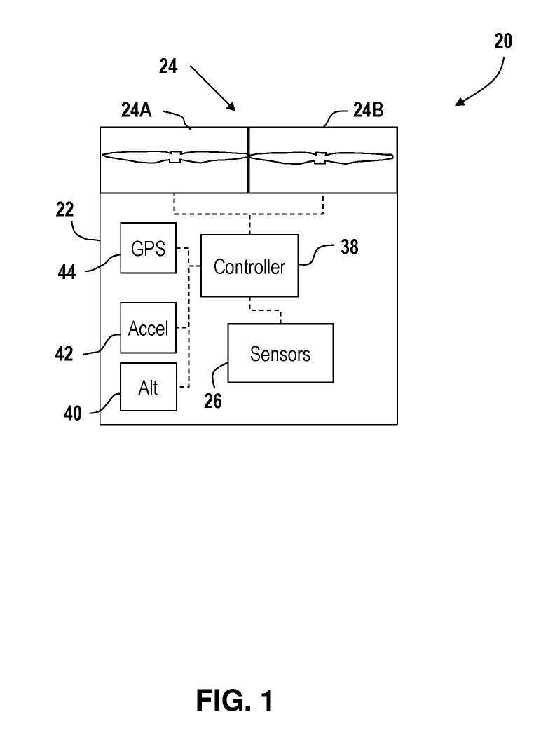

Referring now to FIG. 1, an embodiment is shown of a drone 20 or unmanned aerial vehicle. As used herein, the term “drone” refers to an aerial vehicle capable of operating autonomously from a human operator to perform a predetermined function. The drone 20 includes a fuselage 22 that supports at least one thrust device 24. In an embodiment, the drone 20 includes a plurality of thrust devices 24A, 24B, such as four thrust devices arranged about the periphery of the fuselage 22. In an embodiment, the thrust devices 24 include propeller member that rotates to produce thrust. The thrust devices 24 may be configurable to provide both lift (vertical thrust) and lateral thrust (horizontal thrust). The vertical and horizontal components of the thrust allow the changing of the altitude, lateral movement and orientation (attitude) of the drone 20.

In the exemplary embodiment, the fuselage 22 and thrust devices 24 are sized and configured to carry a plurality of sensors 26. In exemplary embodiments, the sensors 26 can include image capture equipment, video capture equipment, audio capture equipment, depth capture equipment, or any other type of data capture equipment. In one embodiment, the sensors 26 include a camera, an infra-red camera, and one or more gas sensors. In some embodiments, the sensors can include a variety of chemical sensors configured to detect the presence of specific compounds. It may also include an electromagnetic sensor to remotely check the presence of energized wires.

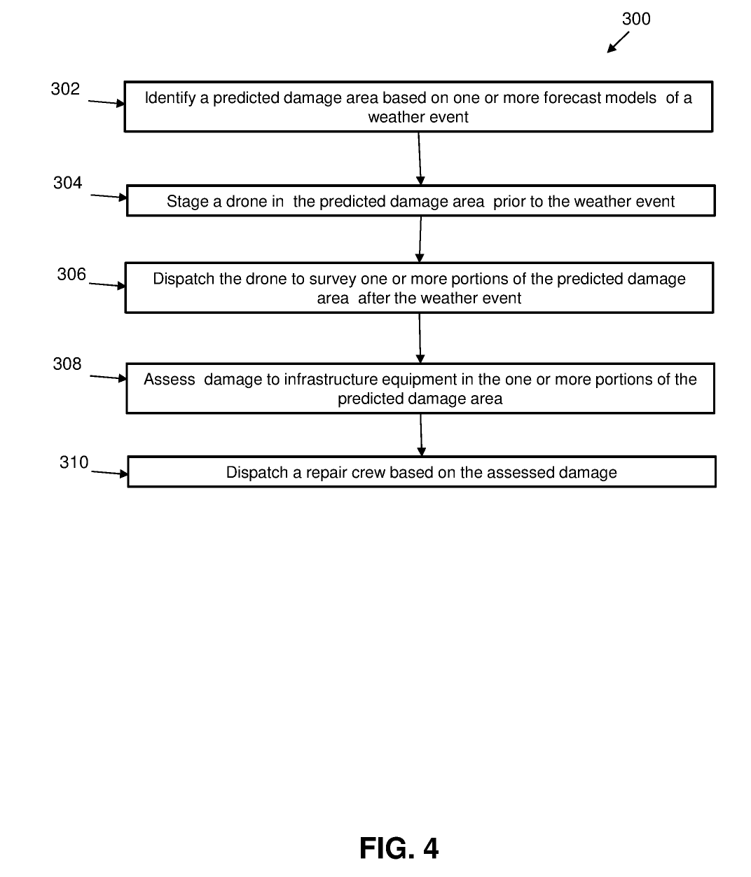

The drone 20 includes a controller 38 having a processing circuit. The controller 38 may include processors that are responsive to operation control methods embodied in application code such as those shown in FIG. 4. These methods are embodied in computer instructions written to be executed by the processor, such as in the form of software. The controller 38 is coupled to transmit and receive signals from the thrust devices 24 to determine and change their operational states (for example adjust lift from thrust devices 24). The controller 38 may further be coupled to one or more devices that enable to the controller to determine the position, orientation, and altitude of the drone 20. In an embodiment, these devices include an altimeter 40, a gyroscope or accelerometers 42 or a global positioning satellite (GPS) system 44. The controller 38 is further coupled to the one or more sensors 26. In exemplary embodiments, the drone 20 is configured to simultaneously detect the presence a chemical compound, such as methane gas (for natural gas leaks) or Sulfur Hexafluoride (an insulating gas used in some switching equipment) or fumes from oil cooled transformers, while recording its GPS location.

In exemplary embodiments, the drone 20 includes a camera that captures images that are processed with photogrammetry tools to develop a three-dimensional model of the environment the drone is flying in. Such model can be stereographic imaging of an object from images acquired by a single camera under different viewing angle and altitudes.

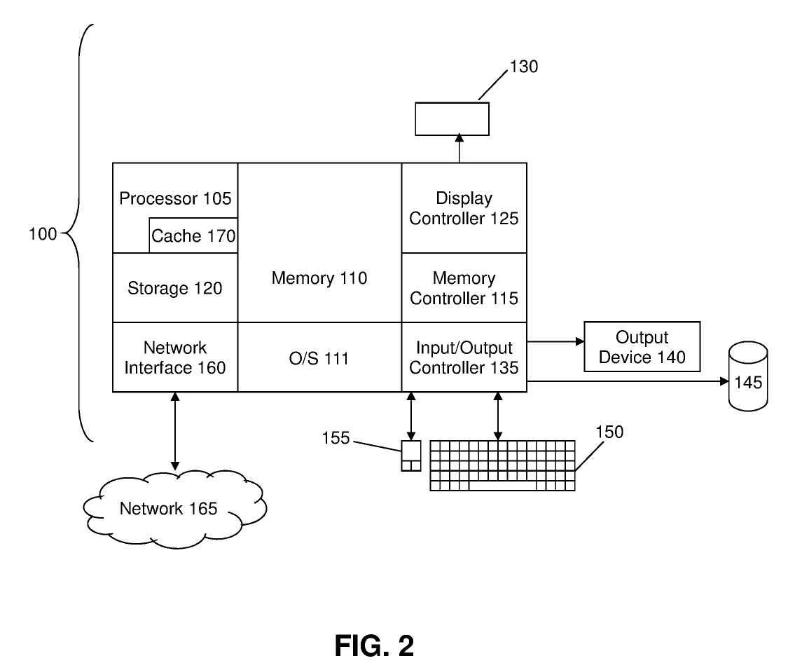

FIG. 2 illustrates a block diagram of a controller 100 for use in implementing a system or method according to some embodiments. The systems and methods described herein may be implemented in hardware, software (e.g., firmware), or a combination thereof. In some embodiments, the methods described may be implemented, at least in part, in hardware and may be part of the microprocessor of a special or general-purpose controller 38, such as a personal computer, workstation, minicomputer, or mainframe computer.

In some embodiments, as shown in FIG. 2, the controller 100 includes a processor 105, memory 110 coupled to a memory controller 115, and one or more input devices 145 and/or output devices 140, such as peripheral or control devices that are communicatively coupled via a local I/O controller 135. These devices 140 and 145 may include, for example, battery sensors, position sensors, cameras, microphones and the like. Input devices such as a conventional keyboard 150 and mouse 155 may be coupled to the I/O controller. The I/O controller 135 may be, for example, one or more buses or other wired or wireless connections, as are known in the art. The I/O controller 135 may have additional elements, which are omitted for simplicity, such as controllers, buffers (caches), drivers, repeaters, and receivers, to enable communications.

The I/O devices 140, 145 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like. This includes but is not limited to storage of scanned information in the Cloud while in-flight. Storage may include GIS information downloaded from the utility before the flight.

The processor 105 is a hardware device for executing hardware instructions or software, particularly those stored in memory 110. The processor 105 may be a custom made or commercially available processor, a central processing unit (CPU), an auxiliary processor among several processors associated with the controller 38, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read-only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 2, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive or solid state drive. The stored instructions in memory 110 or in storage 120 may include those enabling the processor to execute one or more aspects of the systems and methods of this disclosure.

The controller 100 may further include a display controller 125 coupled to a user interface or display 130. In some embodiments, the display 130 may be an LCD screen. In some embodiments, the controller 100 may further include a network interface 160 for coupling to a network 165. The network 165 may be an IP-based network for communication between the controller 38 and an external server, client and the like via a broadband connection. The network 165 transmits and receives data between the controller 38 and external systems. In an embodiment, the external system may be the UAV 20. In some embodiments, the network 165 may be a managed IP network administered by a service provider. The network 165 may be implemented in a wireless fashion, e.g., using wireless protocols and technologies, such as Wi-Fi, WiMAX, satellite, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods according to this disclosure may be embodied, in whole or in part, in computer program products or in controller 100, such as that illustrated in FIG. 2.

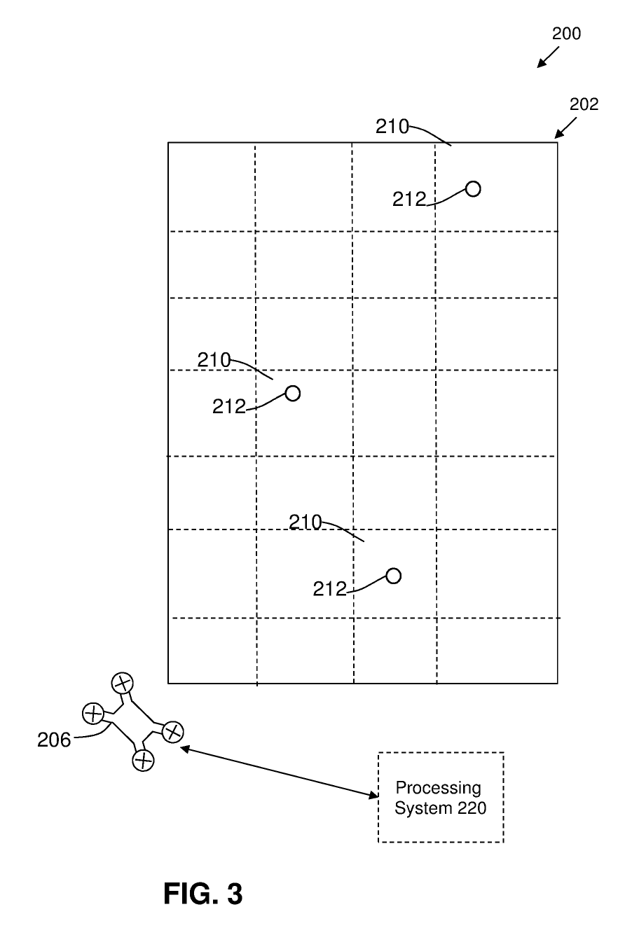

Referring now to FIG. 3, a plan view of a system 200 for enhancing power outage recovery using a drone 206 in accordance with an embodiment is shown. In exemplary embodiments, a processing system 220, such as the one shown in FIG. 2, is configured to analyze one or more forecast models of a weather event for a geographic region 202. The processing system 220 identifies one or more predicted damage areas 210 in the geographic region 202 based the one or more forecast models of the weather event. Once the predicted damage areas 210 are identified, the processing system 202 dispatches drones 206 to a staging location 212 in the predicted damage areas 210. After the weather event has passed, the drones 206 are dispatched to survey the one or more portions of the predicted damage areas 210.

In exemplary embodiments, the drones 206 include cameras that capture images of the one or more portions of the predicted damage areas 210. In some embodiments, the drone 206 can be in communication, either directly or indirectly, with the processing system 220 that is used to analyze the images captured by the drone 206. In other embodiments, the drone 206 can utilize its onboard processor to analyze the images captured by the drone 206.

In exemplary embodiments, the one or more portions of the predicted damage areas 210 that are surveyed by the drone 206 can be identified based on data received from smart devices, such as smart meters, disposed within the infrastructure, from telephone calls reporting damage or service outages, or from various other sources. In exemplary embodiments, the infrastructure can include electrical power infrastructure, such as electrical distribution system wires, poles, and substations and the infrastructure damage can include broken poles, downed wires, broken trees (especially those now in contact with the wires), broken pole-top equipment, etc. In exemplary embodiments, the drones 206 can be used to capture images of the predicted damage areas 210 before the weather event. These images can be compared to the images captured by the drone after the weather event to aid in identifying damage to infrastructure equipment. In exemplary embodiments, the observed damage information can be used to refine the model used to predict the damage that will be caused by weather events.

Referring now to FIG. 4, a flow diagram of a method 300 for enhancing power outage recovery using a drone is depicted. As shown at block 302, the method 300 includes identifying a predicted damage area based on one or more forecast models of a weather event. Next, as shown at block 304, the method 300 includes staging a drone in the predicted damage area prior to the weather event. In exemplary embodiments, more than one drone can be staged in a predicted damage area and the number of drones staged in a predicted damage area is based on the amount of damage predicted.

Next, as shown at block 306, the method 300 includes dispatching the drone to survey one or more portions of the predicted damage area after the weather event. In exemplary embodiments, the one or more portions of the predicted damage areas 210 that are surveyed by the drone 206 can be identified based on data received from smart devices, such as smart meters located at the end points of power consumption, disposed within the infrastructure, from calls reporting damage or service outages, or from various other sources. For example, Advanced Metering Infrastructure (i.e., Smart Meters and data from a Distribution Management System or Outage Management System) can be utilized to the one or more portions of the predicted damage areas 210 that are surveyed by the drone 206. In exemplary embodiments, the drone tags the captured images with real-time GPS information while in flight.

Continuing with reference to FIG. 3, the method 300 also includes assessing damage to infrastructure equipment in the one or more portions of the predicted damage area, as shown at block 308. In exemplary embodiments, the assessment of the damage to infrastructure equipment can be performed by a person or automatically through the use of image processing techniques to identify instances of infrastructure damage. Such image processing techniques can include edge detection, pattern matching, component identification and relative positions of same. In addition, the assessment of the damage to infrastructure equipment can include comparing the images captured after the weather event to images captured before the weather event to identify damage to infrastructure equipment. Next, as shown at block 310, the method 300 includes dispatching a repair crew based on the assessed damage. In exemplary embodiments, the images captured by the drones during the survey are provided to the dispatched repair crews, in order to inform crew management what repairs are needed in areas without power. In some cases, the drone view may reduce the risk to the crew of ascending to an elevated position to view damage from above.

In exemplary embodiments, actual weather data is captured during the weather event and this data is analyzed using one or more computer models to identify the one or more portions of the predicted damage area that will be surveyed by the drone after the weather event. In exemplary embodiments, analyzing the actual weather data can identify regions of likely damage that have either not resulting in power outage yet, or if a power outage has occurred, it has not been reported yet. Running a post-storm damage model can include running a weather forecast with data assimilated from observed weather and environmental data.

In exemplary embodiments, the sum of total hours of surveillance time for a drone in a day is limited by the need to charge batteries, perform maintenance, recommended usage guidance, limited on-board storage capacity, etc. Accordingly, the drones need to be dispatched to a geographic area into areas in which the predicted damage will be the most severe in order to best utilize the limited resources of the drones. In one example, a damaging weather event has lasted for a time period [t0, t1). Let D(r) be the damage count that was predicted for a region r, for the time period [t0−δ, t1+ε), where δ, ε are small margins (positive or negative), which can be equal to 0. In exemplary embodiments, D(r) can be a numeric quantity, or a severity level (e.g. low, medium, high). The regions (r) are subdivisions of the entire service territory, for example, cells of a grid, substation regions, service regions, etc. Hᵢ(r) hours of surveillance time can be assigned to a UAV Uᵢ for region r, such that H(r)=f(D(r)) where f( ) is a predetermined function.

In exemplary embodiments, a method of planning and scheduling drone surveillance for damage to electrical power infrastructure, such as distribution system wires, poles, and substations based on a weather forecast and a damage model that uses the weather forecast to predict damage locations is provided. In one embodiment, the flight path of the drone is designed to be within a certain distance of the infrastructure predicted to be damaged, or suspected to be damaged based on smart meter or customer phone call data. In exemplary embodiments, the flight path of the drone is not allowed to cross into certain regions for privacy and security constraints but is allowed over streets and utility rights of way. In one embodiment, the drone includes a camera that is configured to stop recording within certain regions or time periods.

In exemplary embodiments, the use of drone surveillance is beneficial when other forms of surveillance are limited or more expensive in terms of time and resources, such as human surveillance. For example, since fallen trees and their limbs that bring down electrical power wires also often make roads impassable. Since the drone does not have to wait for road debris to be removed, the damage survey can be completed much faster than using ground-based crews. In exemplary embodiments, the drone can be configured to detect trees on the road, and subsequent image analysis may so inform the power company repair crews.

In exemplary embodiments, during normal operation, i.e., not after a severe weather event, the drones can conduct surveys and capture videos of the geographic area that can be used as input to the creation of damage models. For example, the video can be analyzed to identify issues such as trees close to power lines, which increase or decrease the probability of damage. The analysis of the video can further include identifying a type of trees, which can make a future detailed model of trees more likely to uproot and fall intact onto power lines or break off major limbs to cause downed wires, based on the season and rainfall. Trees species with shallow root systems can fall over from flooding rather than wind Snow on trees with leaves causes more tree failures than if the leaves have fallen already

It should be appreciated that while embodiments herein refer to a controller 100 for controlling and managing the drone, this is for exemplary purposes and the claims should not be so limited. In other embodiments, the controlling and managing of the drone may be performed by a plurality of controllers, a distributed computing environment or a cloud computing environment. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

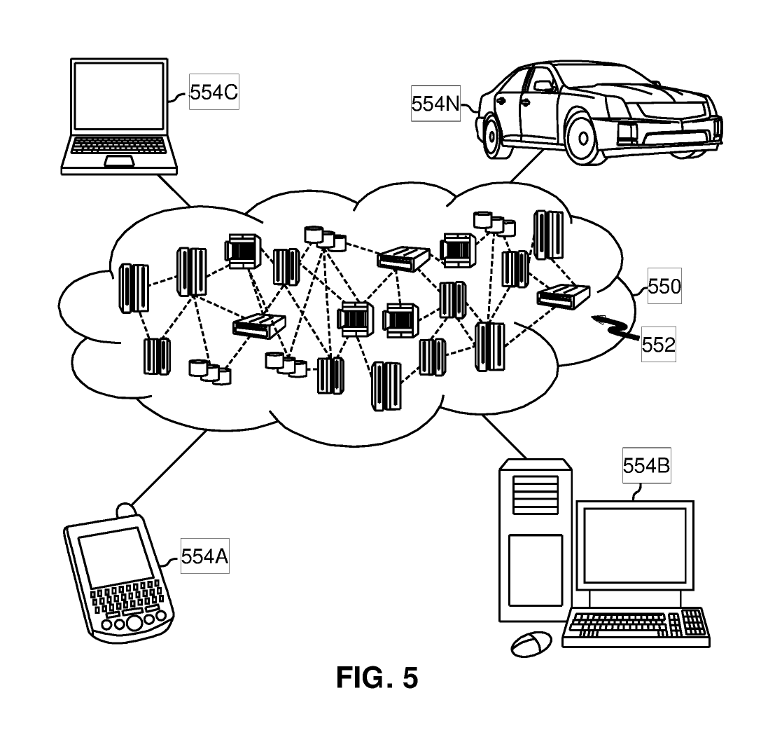

Referring now to FIG. 5, illustrative cloud computing environment 550 is depicted. As shown, cloud computing environment 350 comprises one or more cloud computing nodes 552 with which local computing devices used by cloud consumers, such as, for example, personal digital assistant (PDA) or cellular telephone 554A, desktop computer 554B, laptop computer 554C, and/or automobile computer system 554N may communicate. Nodes 552 may communicate with one another. They may be grouped (not shown) physically or virtually, in one or more networks, such as Private, Community, Public, or Hybrid clouds as described hereinabove, or a combination thereof. This allows cloud computing environment 550 to offer infrastructure, platforms and/or software as services for which a cloud consumer does not need to maintain resources on a local computing device. It is understood that the types of computing devices 554A-N shown in FIG. 5 are intended to be illustrative only and that computing nodes 552 and cloud computing environment 550 can communicate with any type of computerized device over any type of network and/or network addressable connection (e.g., using a web browser).

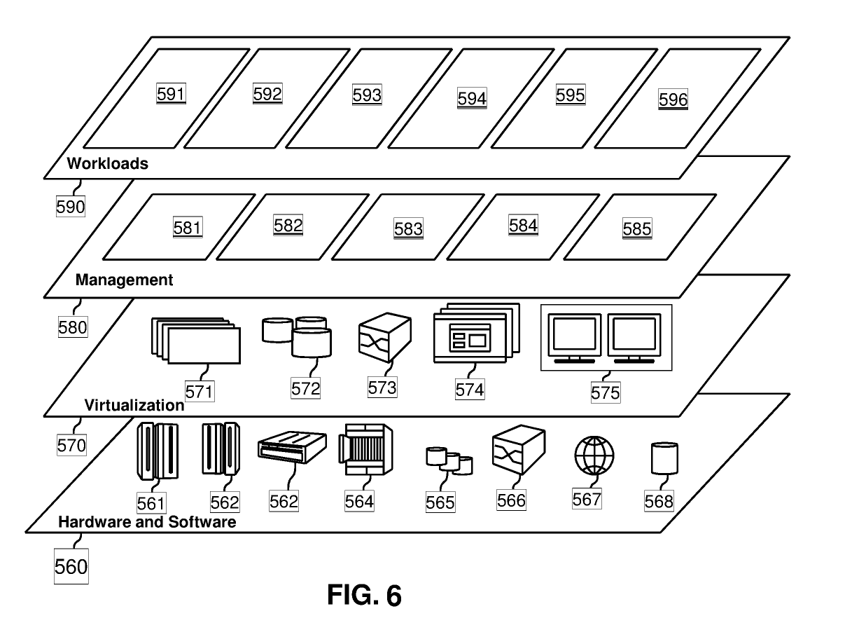

Referring now to FIG. 6, a set of functional abstraction layers provided by cloud computing environment 550 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provides pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: mapping and navigation 591; software development and lifecycle management 592; virtual classroom education delivery 593; data analytics processing 594; transaction processing 595; and a UAV positioning and monitoring management 596. The UAV positioning and monitoring management 596 may perform one or more methods for enhancing power outage recovery using unmanned aerial vehicles, such as but not limited to the methods described in reference to FIG. 4 for example.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for enhancing power outage recovery using a drone, the method comprising:
identifying a predicted damage area based on one or more forecast models of a weather event;
staging a drone in the predicted damage area prior to the weather event;
dispatching the drone to survey one or more portions of the predicted damage area after the weather event;
assessing damage to infrastructure equipment in the one or more portions of the predicted damage area; and
dispatching a repair crew based on the assessed damage.

2. The computer-implemented method of claim 1, further comprising surveying the one or more portions of the predicted damage area after the weather event and wherein assessing the damage to infrastructure equipment includes comparing images captured by the drone after the weather event with images captured by the drone before the weather event.

3. The computer-implemented method of claim 1, wherein surveying the one or more portions of the predicted damage area after the weather event includes capturing a plurality of images of the one or more portions of the predicted damage area and tagging each of the plurality of images with a global positioning system identification.

4. The computer-implemented method of claim 3, wherein assessing the damage to infrastructure equipment includes performing edge detection and pattern matching image analysis on one or more of the plurality of images.

5. The computer-implemented method of claim 3, wherein the repair crew is provided with one or more of the plurality of images that correspond to the damage that the repair crew is being dispatched to repair.

6. The computer-implemented method of claim 1, wherein the one or more portions of the predicted damage area after the weather event are identified based on service disruption data received from smart meters.

7. The computer-implemented method of claim 1, wherein the one or more portions of the predicted damage area after the weather event are identified based on service disruption data reported by customers.

8. The computer-implemented method of claim 1, wherein the one or more portions of the predicted damage area after the weather event are identified based on weather data collected during the weather event.

9. The computer-implemented method of claim 1, wherein dispatching the drone to survey the one or more portions of the predicted damage area after the weather event includes creating a flight plan for the drone that includes flying the drone within a certain distance of the infrastructure equipment predicted to be damaged and preventing the drone from flying within restricted areas.
